(19) United States
(12) Patent Application Publication
(10) Pub. No.: US 2010/0245555 A1
(43) Pub. Date: Sep. 30, 2010

(54) METHOD AND SYSTEM TO MEASURE BODY VOLUME/SURFACE AREA, ESTIMATE DENSITY AND BODY COMPOSITION BASED UPON DIGITAL IMAGE ASSESSMENT

(76) Inventors: Antonio Talluri, Bagno A Ripoli (FI) (IT); Michaeal G. Singer, Harrisville, MI (US)

Correspondence Address: WEINER & BURT, P.C., 635 N US-23, POB 186, HARRISVILLE, MI, 48740, US

(21) Appl. No.: 12/599,295

(22) PCT Filed: May 22, 2008
(86) PCT No.: PCT/US08/64535

§ 371 Date: Nov. 8, 2009

Related U.S. Application Data
(60) Provisional application No. 60/931,232, filed on May 22, 2007.

(51) Int. Cl. H04N 7/18

(52) U.S. Cl. 348/77; 382/128; 348/E07.085

(57) ABSTRACT

A method and system to digitally measure area/volume and body surface area of a person and estimate corresponding density and composition as related to a fixed reference frame. This Digital Image Volume Assessment System (DIVAS™) has many desirable features, such as computerized accuracy, precision, convenience, minimal operator expertise and subject compliance is required, and it is economical and expeditious.

This application claims priority from U.S. Provisional Patent Application 60/931,232 filed May 22, 2007.

The present invention generally relates to a method and system to digitally measure the area/volume and body surface area of a person and estimate corresponding density and composition as related to a fixed reference frame. This Digital Image Volume Assessment System (DIVAS™) has many desirable features, such as computerized accuracy, precision, convenience, minimal operator expertise and subject compliance is required, and it is economical and expeditious.

More particularly a preferred embodiment of the invention relates to the aforementioned method and system to be used to estimate the body composition and body surface area of a person.

Accurate quantification of the body's volume, surface area, and composition is of interest for the assessment of health and wellness, nutrition and diet, as well as exercise and activity.

Conventional methods are gross estimates based upon multiple assumptions and often complex techniques requiring significant operator expertise and subject compliance.

It is a desideratum of the present invention to avoid the animadversions of the conventional methods.

### SUMMARY OF THE INVENTION

The invention provides a method of digitally ascertaining one or more biometric parameters of a subject, comprising the steps of:
providing a backdrop of contrasting color to that of the subject within a standardized and controlled clearly-defined reference frame;
presenting the subject in at least a partial covering having a color which contrasts with the subject and with said contrasting backdrop within said standardized and controlled reference frame;
orienting the subject in a first predetermined position relative to a digital camera so that the subject is in said standardized and controlled reference frame and is disposed between said digital camera and said backdrop;
taking a first digital photograph of the subject in said first predetermined position;
counting from said first digital photograph and then subtracting individual pixels from a reference value of total available pixels within said standardized and controlled demonstrative reference frame;
orienting the subject in a second predetermined position relative to and at a predetermined distance from a digital camera so that the subject is in said standardized and controlled demonstrative reference frame and is disposed between said digital camera and said backdrop;
taking a second digital photograph of the subject in said first predetermined position;
counting from said second digital photograph and then subtracting individual pixels from a reference value of total available pixels within said standardized and controlled demonstrative reference frame; and
determining from said counting and subtracting steps one or more biometric parameters of the subject.

The invention also provides a system for digitally ascertaining one or more biometric parameters of a subject, comprising:
first means for providing a homogeneous colored backdrop within a standardized and controlled demonstrative reference frame;
second means for presenting the subject in at least a partial covering having a color which contrasts with the subject and with said backdrop within said standardized and controlled demonstrative reference frame;
third means for orienting the subject in a first predetermined position relative to and at a predetermined distance from a digital camera so that the subject is in said standardized and controlled demonstrative reference frame and is disposed between said digital camera and said back-lit white backdrop;
fourth means for taking a first digital photograph of the subject in said first predetermined position;
fifth means for counting from said first digital photograph and then subtracting individual pixels from a reference value of total available pixels within said standardized and controlled demonstrative reference frame;
sixth means for orienting the subject in a second predetermined position relative to and at a predetermined distance from a digital camera so that the subject is in said standardized and controlled demonstrative reference frame and is disposed between said digital camera and said backdrop;
said fourth mean further taking a second digital photograph of the subject in said first predetermined position;
said sixth means counting from said second digital photograph and then subtracting individual pixels from a reference value of total available pixels within said standardized and controlled demonstrative reference frame; and
seventh means for determining from said counting and subtracting steps one or more biometric parameters of the subject.

Accordingly an object of this invention is to provide a method and system to digitally measure the area/volume of a subject person.

Another object of the invention is to provide an estimate of the subject's surface area. Another object of the invention is to provide an estimate of the subject's body composition.

Another object of the invention is to provide an automated computerized software program and calculation, reporting, and archive for serial comparison of the test results.

These and other objectives are achieved by providing a new and improved computerized system for performing the steps of the method in an effective, convenient and economical digital imaging based method.

A more complete appreciation of the invention and many of the attendant advantages thereof will be readily recognized and attained by reference to the following detailed description when read in conjunction with the accompanying drawings.

### BRIEF DESCRIPTIONS OF THE DRAWINGS

FIG. 1 shows a DIVAS™ flow chart.

FIG. 2 illustrates DIVAS™ floor setup which graphically displays the overall configuration of the logistical placement of the system.

FIG. 3 depicts details of the backdrop and lighting to display the background and light system

FIG. 4 illustrates details of the base, backdrop, and lighting system

FIG. 5 shows details the front view and placement of the subject in the system on the base.

FIG. 6 depicts details the front view contrast image for analysis.

FIG. 7 shows details the side view and placement of the subject in the system on the base.

FIG. 8 depicts details the side view contrast image for analysis.

FIG. 9 illustrates the DIVAS™ computer system.

### DETAILED DESCRIPTION OF THE PRESENT INVENTION

The inventive method on which the inventive system is based captures the digital image of the subject in controlled contrasted reference to a fixed backdrop obtaining an image which is computerized in which the contrasting pixels of subject and background are counted to measure area/volume, calculate density, measure body surface area and estimate body composition.

The estimate can be made from single testing sessions, and changes may be tracked serially over time by subsequent measurements made at sufficient time intervals to illustrate variation.

Techniques include novel developments, implementations and application of technologies to standardize the inventive process so it may be applied conveniently, economically, and report accurate results.

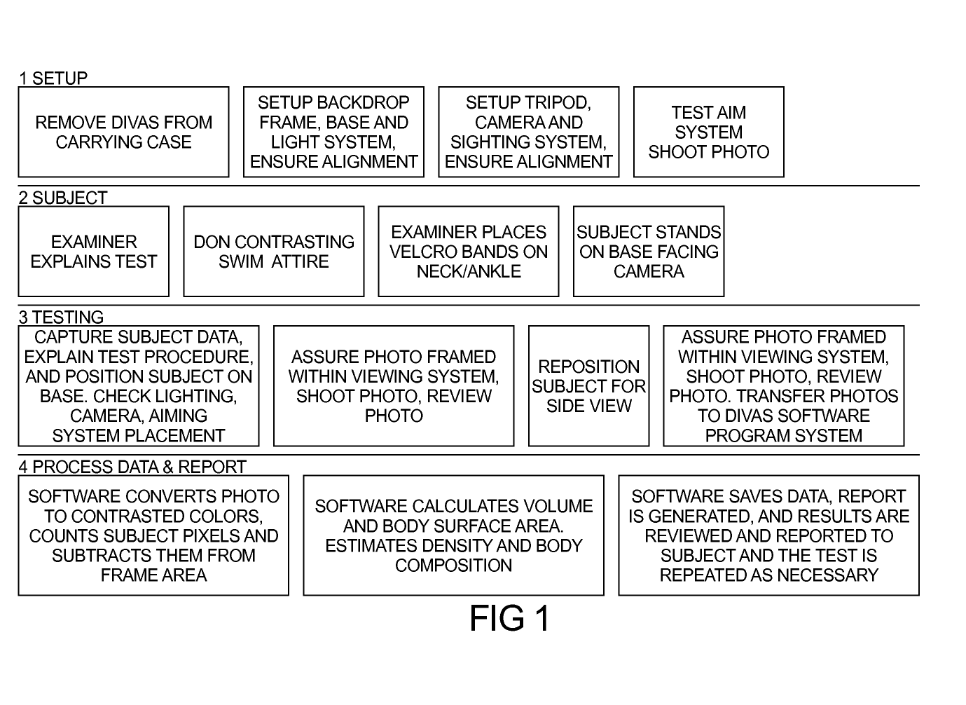

Only one of the many different possible embodiments of the present invention will now be explained with reference to FIGS. 1-9.

By digitally photographing in one or two-views, e.g., front and side views (see FIGS. 5-8), the subject person 10 facing the camera 11, standing erect with hands on hips against a back-lit white backdrop 12 dressed in contrasting swim attire within a standardized and controlled demonstrative reference frame 13, and by then counting and then subtracting the individuals pixels from a reference value of the total available pixels within the reference frame 13, the volume and/or surface area of the individual subject 10 can be accurately measured.

The digital photography process must be precisely controlled as to definition, pixel count, size and detail. The camera 11 is set at a suitable distance to capture the frame 13 and subject 10 within it, utilizing a laser sighted targeting on the subject's umbilicus. The subject's feet and head are digitally removed from the photograph by the pixel counting and results calculating software program.

A computer software program is utilized to archive, report and calculate the results based upon the measured volume, and utilizing an assumption that the body is comprised of a two-component (compartment) model of only fat and fat free mass possessing reasonably constant density values, the subject's fat and fat-free mass can be estimated. If further anthropometric values such as height, weight, and body mass index are included with gender, race and other variables, then a further refinement of the estimate of the components of the fat-free mass can be estimated, such as, for example, water (body water), protein (cell mass), and mineral (bone).

First, the DIVAS™ system manual is read to familiarize the user with the science, purpose and operation of the system. Next, all component parts of the system are identified and located.

Next, the DIVAS™ software package is loaded on the user's computer system 14 (FIG. 9).

Then, the physical area where the testing is to be done is inspected to ensure that electrical power is available, it is of adequate size, and that there is no excess ambient light or sunlight.

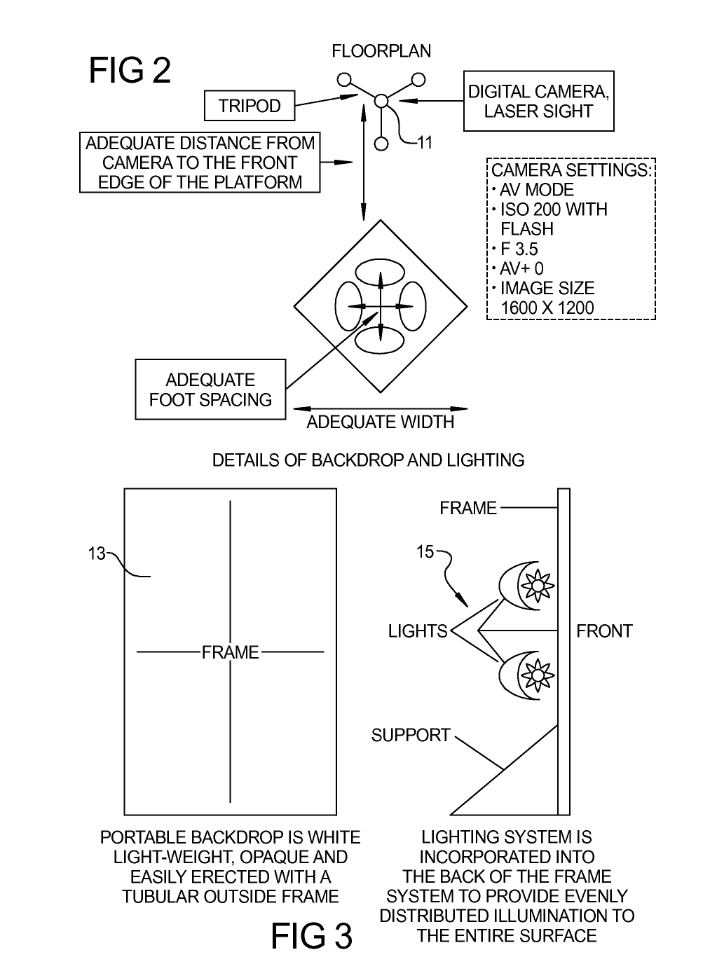

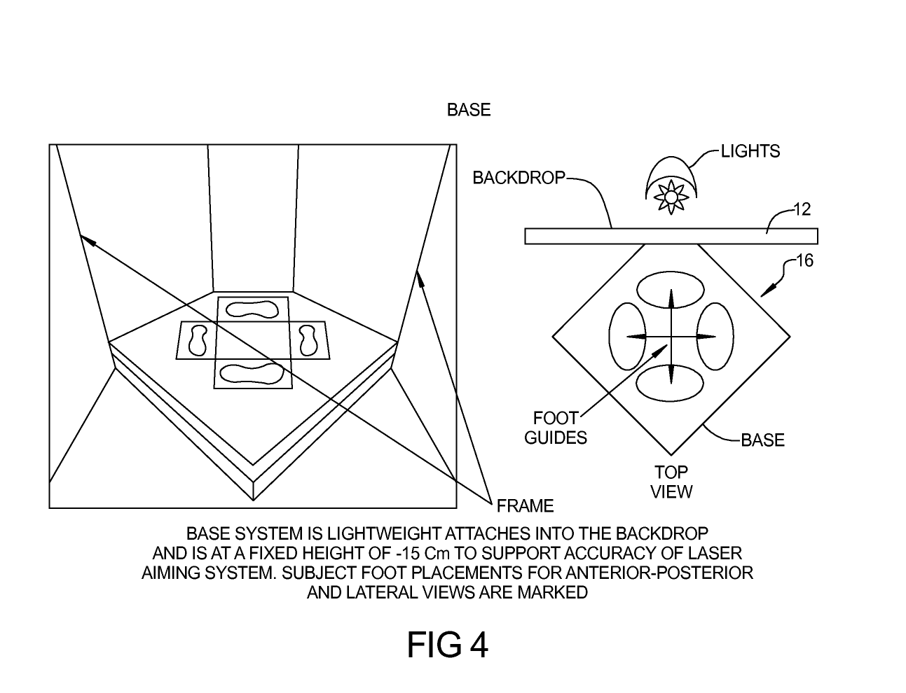

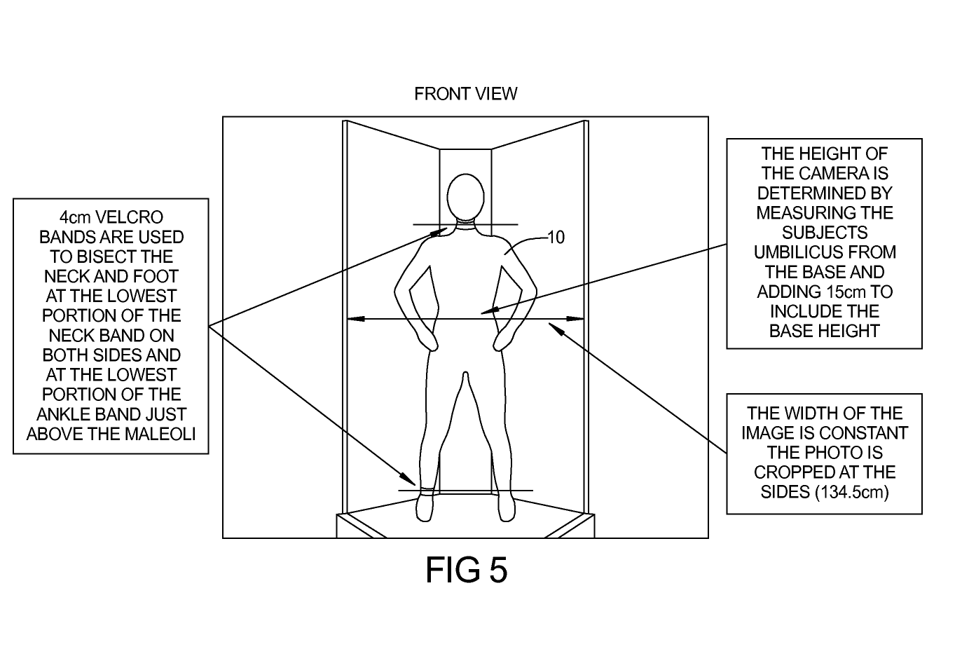

The DIVAS™ system is erected as depicted in FIG. 2; beginning with the backdrop 12 and lighting system 15 as seen in FIG. 3. The lighting system 15 is plugged into the available power outlets, energized and its lights inspected. Next, the base system 16, the backdrop 12, and reference frame 13 are assembled as seen in FIG. 4. Then, the tripod is erected, the camera 11, and laser sighting system are attached (FIG. 2). The sighting system and camera 11 are energized, the frame 13 is sighted in, and a test photo is taken.

The subject 10 is counseled as to the testing procedure; subject information is collected; and the subject 10 is instructed to change into swimwear. The subject 10 is to don swimwear that contrasts with the subject's skin color and the backdrop 12 (FIG. 1).

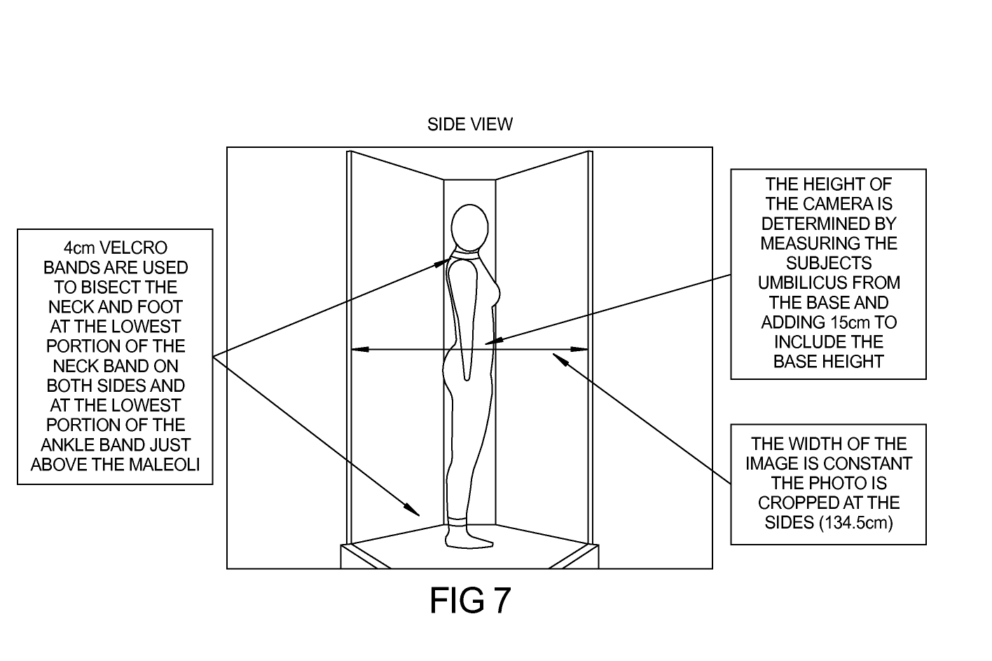

The Velcro marking bands are attached to the subject's neck and ankle and the sighting system is aimed and camera view placed on the subject (FIG. 5). The image is captured and the process is repeated for the side view if it is to be completed (FIG. 7). The examiner ensures both images are adequate and stored on the memory media of the camera system and the subject is released.

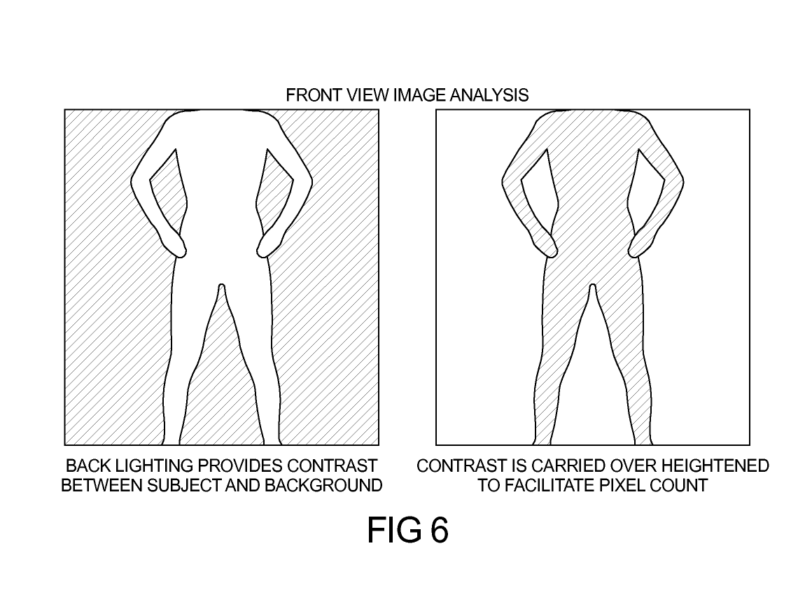

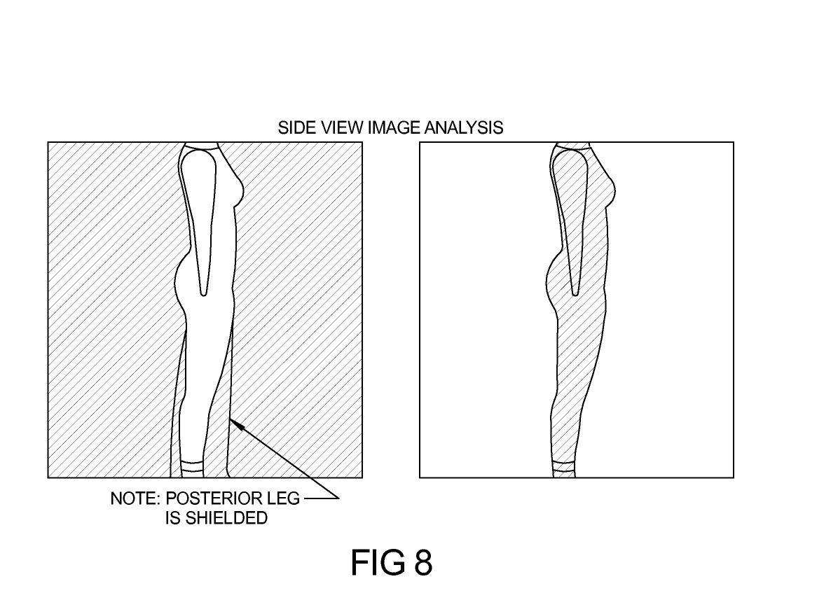

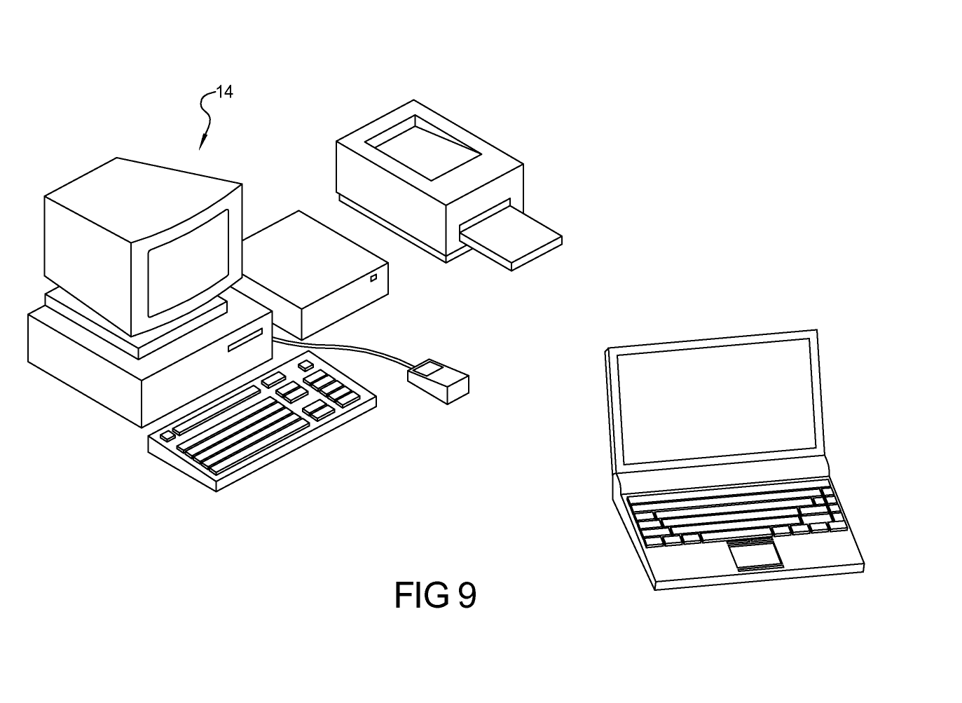

The image data is transferred to the DIVAS™ software program (FIG. 9) and the contrasting image files for both the front and side views (FIGS. 6 and 8) are archived, analyzed, and the report is generated. The reported data includes volume, area, density, body composition, and body surface area.

Over time, serial measurements are made to evaluate changes induced by diet, activity, exercise or other conditions that may result in change or require new results.

The following describes a demonstration of the invention for estimating body volume in men and women using the DIVAS™ system.

The purpose of the demonstration was to generate a body volume (BV) estimation equation using only the DIVAS™ system with BV from hydrostatic weighing (HW), and cross-validate the equation against BV from HW.

One hundred and fifty-three college-age men and women (21.78±2.6 years; 62 men, 91 women) volunteered to have their BV estimated by HW and complete DIVAS™ system measurements.

Thirty men and women from each group were randomly assigned to the cross-validation group (HW BV=68.05±12.87 L), while the remaining ninety-three subjects were used to generate the BV equation (HW BV=67.61±13.39 L).

The DIVAS™ system converted the front and side digital images [width=600 pixels (actual width=134.5 cm); height=malleoli to top of trapezius] from each subject to red (body) pixels and black (empty) pixels.

DIVAS™ system measurements included front and side body pixels, empty space pixels, body pixels to empty space pixel percentage, total body pixels, and total body pixels to empty pixel space percentage.

Sex (men=2; women=1), side body pixels (SBP), and total body pixels to empty pixel space percentage (TBPP) were identified as the most significant predictors from a stepwise analysis with a resulting r² of 0.976 and standard error of estimate (SEE) of 2.07 L.

Cross-validation results indicated good agreements for all subjects and between the men and women.

Mean BV differences (CE) for DIVAS™ system were not significantly different (p>0.05) from HW BV and ranged from −0.47 L in the women to 0.11 L for all the subjects.

Total error (TE) and SEE values were equal to or less than 1.59 L, and r² values were equal to or greater than 0.98.

The limits of agreements produced no significant trends (p>0.05) with the largest limits for men (0.23±3.07 L; CE±1.96×SD).

All TE values were equal to or less than 2.2% of the mean HW BV.

Additionally, the DIVAS™ system produced a low BV SEM in 11 men and women measured 24 to 48 hours apart, compared to the HW BV SEM (<IL).

The new DIVAS™ system-based BV equation produced low SEE and TE values, high r² values, and non-significant CE values and trends for men and women. Therefore, the DIVAS™ system can be considered a valid method for estimating BV in college-age men and women using the following equation: BV=0.00111×SBP+2.11036×TBPP−0.60163×Sex−70.11181.

There has been described hereinabove an unique and novel embodiment of the present invention which can be practiced and constructed in many different ways and configurations.

It should be understood that many changes, modifications, variations, and other uses and applications will become apparent to those persons skilled in this particular area of technology and to others after having been exposed to the present patent application.

Any and all such changes, modifications, variations and other uses and applications which do not depart from the spirit and scope of the present invention are therefore covered by and embraced within the present invention and the patent claims set forth hereinbelow.

1. A method of digitally ascertaining one or more biometric parameters of a subject, comprising the steps of:
providing a backdrop of contrasting color to that of the subject within a standardized and controlled clearly-defined reference frame;
presenting the subject in at least a partial covering having a color which contrasts with the subject and with said contrasting backdrop within said standardized and controlled reference frame;
orienting the subject in a first predetermined position relative to a digital camera so that the subject is in said standardized and controlled reference frame and is disposed between said digital camera and said backdrop;
taking a first digital photograph of the subject in said first predetermined position;
counting from said first digital photograph and then subtracting individual pixels from a reference value of total available pixels within said standardized and controlled demonstrative reference frame;
orienting the subject in a second predetermined position relative to and at a predetermined distance from a digital camera so that the subject is in said standardized and controlled demonstrative reference frame and is disposed between said digital camera and said backdrop;
taking a second digital photograph of the subject in said first predetermined position;
counting from said second digital photograph and then subtracting individual pixels from a reference value of total available pixels within said standardized and controlled demonstrative reference frame; and
determining from said counting and subtracting steps one or more biometric parameters of the subject.

2. A method according to claim 1, including the steps of:
transferring image data from said first and second digital photographs to a software program which archives and analyzes said image data; and
reporting data from said software program, which reported data includes volume, area, density, body composition, and body surface area of the subject.

3. A method according to claim 1, including the steps of:
transferring image data from said first and second digital photographs to a computer software program; and
using said computer software program to archive, calculate and report results, based upon measured volume of the subject and an assumption that the subject is comprised of a two-component model of only fat mass and fat-free mass possessing substantially constant density values, which estimate the fat mass and the fat-free mass of the subject.

4. A method according to claim 2, including the steps of:
using said software program to archive, calculate and report results, based upon measured volume of the subject and an assumption that the subject is comprised of a two-component model of only fat mass and fat-free mass possessing substantially constant density values, which estimate the fat mass and the fat-free mass of the subject.

5. A method according to claim 1, wherein:
the subject is a person;
said covering is swim attire; and
including the step of:
utilizing a laser- and/or optical-sighted targeting on the subject person's umbilicus in positioning said digital camera.

6. A method according to claim 1, including the step of:
digitally measuring area/volume of the subject.

7. A method according to claim 1, including the step of:
providing an estimate of surface area of the subject.

8. A method according to claim 1, including the step of:
orienting said second predetermined position of the subject at a 90° angle relative to said first predetermined position of the subject.

9. A method according to claim 1, including the step of:
providing an estimate of body composition of the subject.

10. A method according to claim 1, including the step of:
providing an automated computerized software program and calculation, reporting and archiving for serial comparison of test results over time.

11. A system for digitally ascertaining one or more biometric parameters of a subject, comprising:
first means for providing a homogeneous colored backdrop within a standardized and controlled demonstrative reference frame;
second means for presenting the subject in at least a partial covering having a color which contrasts with the subject and with said backdrop within said standardized and controlled demonstrative reference frame;
third means for orienting the subject in a first predetermined position relative to and at a predetermined distance from a digital camera so that the subject is in said standardized and controlled demonstrative reference frame and is disposed between said digital camera and said back-lit white backdrop;
fourth means for taking a first digital photograph of the subject in said first predetermined position;
fifth means for counting from said first digital photograph and then subtracting individual pixels from a reference value of total available pixels within said standardized and controlled demonstrative reference frame;
sixth means for orienting the subject in a second predetermined position relative to and at a predetermined distance from a digital camera so that the subject is in said standardized and controlled demonstrative reference frame and is disposed between said digital camera and said backdrop;
said fourth mean further taking a second digital photograph of the subject in said first predetermined position;
said sixth means counting from said second digital photograph and then subtracting individual pixels from a reference value of total available pixels within said standardized and controlled demonstrative reference frame; and
seventh means for determining from said counting and subtracting steps one or more biometric parameters of the subject.

12. A system according to claim 11, including:
eighth means for transferring image data from said first and second digital photographs to a software program which archives and analyzes said image data; and
ninth means for reporting data from said software program, which reported data includes volume, area, density, body composition, and body surface area of the subject.

13. A system according to claim 11, including:
eighth means for transferring image data from said first and second digital photographs to a computer software program; and
ninth means for using said computer software program to archive, calculate and report results, based upon measured volume of the subject and an assumption that the subject is comprised of a two-component model of only fat mass and fat-free mass possessing substantially constant density values, which estimate the fat mass and the fat-free mass of the subject.

14. A system according to claim 12, wherein:
said ninth means uses said software program to archive, calculate and report results, based upon measured volume of the subject and an assumption that the subject is comprised of a two-component model of only fat mass and fat-free mass possessing substantially constant density values, which estimate the fat mass and the fat-free mass of the subject.

15. A system according to claim 11, wherein:
the subject is a person;
said covering is swim attire; and
including a laser- and/or optical-sighted targeting on the subject person's umbilicus in positioning said digital camera.

16. A system according to claim 11, wherein:
the system digitally measures area/volume of the subject.

17. A system according to claim 11, wherein:
the system provides an estimate of surface area of the subject.

18. A system according to claim 11, including:
orienting said second predetermined position of the subject at a 90° angle relative to said first predetermined position of the subject.

19. A system according to claim 11, wherein:
the system provides an estimate of body composition of the subject.

20. A system according to claim 11, including:
means for providing an automated computerized software program and calculation, reporting and archiving for serial comparison of test results over time.
